(19) United States
(12) Patent Application Publication
(10) Pub. No.: US 2018/0091191 A1
(43) Pub. Date: Mar. 29, 2018

(54) Communication Module for the Charging Process of a Vehicle

(71) Applicant: Bayerische Motoren Werke Aktiengesellschaft, Muenchen (DE)

(72) Inventors: Jens BERGER, Muenchen (DE); Cueneyt TUEREL, Muenchen (DE)

(21) Appl. No.: 15/809,465

(22) Filed: Nov. 10, 2017

Related U.S. Application Data
(63) Continuation of application No. PCT/EP2016/060325, filed on May 9, 2016.

(30) Foreign Application Priority Data
May 12, 2015 (DE) 10 2015 208 786.7

(51) Int. Cl. H04B 3/54; B60L 11/18

(52) U.S. Cl. CPC H04B 3/542; B60L 11/1818; H04W 4/008; B60L 2230/16; B60L 2230/12; B60L 11/1824

(57) ABSTRACT

A communication module for an electrical charging process of a vehicle is provided. The vehicle communicates with a charging station via a charging cable using a first communication protocol, and the charging station is designed to communicate via the charging cable using a second communication protocol. The communication module is configured to receive charging station data from the charging station in accordance with the second communication protocol, and to send data corresponding to the charging station data to the vehicle, either using the first communication protocol if the first communication protocol allows the charging station data to be transmitted via the charging cable to the vehicle, or using a transmission medium such as a wireless connection to a user unit if the first communication protocol does not allow the charging station data to be transmitted to the vehicle over the charging cable.

### CROSS REFERENCE TO RELATED APPLICATIONS

This application is a continuation of PCT International Application No. PCT/EP2016/060325, filed May 9, 2016, which claims priority under 35 U.S.C. § 119 from German Patent Application No. 10 2015 208 786.7, filed May 12, 2015, the entire disclosures of which are herein expressly incorporated by reference.

### BACKGROUND AND SUMMARY OF THE INVENTION

The invention relates to a method and a corresponding device (in particular a corresponding module) for controlling the charging process of an electrically driven vehicle.

Electrically driven vehicles (in particular electric vehicles or plug-in hybrid vehicles) comprise electrical energy stores (e.g. batteries) which can be connected to a charging station and are charged via a charging device of the vehicle. Various conductive, i.e. cable-connected, charging technologies exist for charging the electrical stores of electric and/or hybrid vehicles of this type. In the case of AC charging or alternating-current charging, the charging device which converts the direct current (also referred to as DC current) for charging the electrical store is located in the vehicle. An AC current or alternating current is transmitted on a charging cable between the charging station and the vehicle. In the case of DC charging or direct-current charging, the charging device which converts the direct current for charging the electrical store is located in the charging station. A DC current or direct current is thus transmitted on the charging cable. DC charging is often also referred to as quick charging, since the charging power in DC charging is greater in most cases than the charging power of AC charging.

The control of the process for charging the energy store of a vehicle typically requires a communication between the vehicle and the charging station. The charging power, for example, that is provided by the charging station for the charging process can be determined in the communication. It may furthermore be advantageous to exchange data relating to the identity of the vehicle, data relating to energy prices, data relating to the payment for the charging energy obtained, etc., in order to optimize the performance of a charging process.

Different communication protocols which enable the exchange of different scopes of information and therefore have a different functional scope can be used for the communication between a vehicle and a charging station. It may occur, in particular, that a vehicle is enabled to use a first communication protocol which differs from a second communication protocol which is supported by a charging station. The first communication protocol may have a restricted functional scope compared with the second communication protocol.

The present document is concerned with the technical object of providing means which enable the user of a vehicle which uses a communication protocol with a restricted functional scope for a charging process to use the functions provided by a charging station in an efficient and user-friendly manner.

According to one aspect, a communication module is described for a cable-connected electrical charging process of a vehicle at a charging station. The communication module can also be referred to as a converter, in particular as a protocol converter. The vehicle and the charging station are interconnected via a charging cable for the charging process. The communication module can be provided as part of the charging cable. In particular, the communication module can be connected via a first cable section of the charging cable to the vehicle and via a second cable section of the charging cable to the charging station. The charging station may comprise, for example, a public charging station and/or a wallbox. The vehicle comprises an energy store for storing electrical energy. The energy store can be charged with electrical energy from the charging station.

The vehicle is configured to communicate via the charging cable according to a first communication protocol. The first communication protocol can be used to control the charging process. In particular, the first communication protocol can enable a charging station to determine whether a vehicle is connected via a charging cable to the charging station. This can be communicated, for example, via a level on a communication line of the charging cable. Furthermore, the first communication protocol can enable a vehicle to determine a maximum charging power which can be provided by a charging station to which the vehicle is connected via a charging cable. This can be communicated, for example, via a pulse-width-modulated (PWM) signal on the communication line of the charging cable. The first communication protocol can be restricted to the exchange of the aforementioned information.

The charging station is configured to communicate via the charging cable according to a second communication protocol, wherein the second communication protocol enables the transmission of data which cannot be transmitted with the first communication protocol. In particular, the second communication protocol can enable the transmission of information which extends beyond the aforementioned information relating to the charging power and the connection of a vehicle.

The communication module is configured to receive charging station data from the charging station according to the second communication protocol (e.g. via a second cable section of the charging cable). The communication module is furthermore configured to transmit data corresponding to the charging station data to the vehicle according to the first communication protocol if the first communication protocol enables the transmission of the charging station data. For example, the provided charging power can be communicated to the vehicle. Conversely, the communication module can be configured to transmit data corresponding to the charging station data via a transmission medium separated from the charging cable to a user unit if the first communication protocol does not enable the transmission of the charging station data.

The communication module thus enables a charging process to be instigated between the vehicle and the charging station, even if the vehicle uses a first communication protocol and the charging station uses a second communication protocol which are different. This is done, in particular, by forwarding charging station data to the vehicle according to the first communication protocol. The communication protocol furthermore enables a user of the vehicle to use additional services which are offered by the charging station. These additional services can be configured and controlled via a separate user unit using the second communication protocol.

The charging cable typically comprises a communication line, in particular a pilot line. The first communication protocol can use a pulse-width-modulated (PWM) signal on the communication line to transmit data (e.g. to transmit the charging power). In particular, the first communication protocol can enable a communication according to the IEC 61851-1 standard. Conversely, the second communication protocol can use Power Line Communication to transmit data on the communication line. In particular, the second communication protocol can enable a communication according to the ISO/IEC 15118 standard via the charging cable. The communication module can thus enable the provision of ISO/IEC 15118 additional services for a vehicle which is restricted to a communication according to the IEC 61851-1 standard. The additional services can be configured and/or controlled via the user unit.

The transmission medium separated from the charging cable may comprise a wireless transmission medium. In particular, the communication module can be configured to set up a WLAN (Wireless Local Area Network) and/or Bluetooth connection to the user unit. This enables a flexible control of additional services by a user.

The user unit may comprise a user interface for a user of the vehicle (in particular for the configuration and/or control of additional services). The user unit may furthermore comprise a software application. In particular, the user unit can be implemented by a software application which is run by a processor. A low-cost and flexible user unit can thus be provided. For example, the software application can be provided on a personal electronic device, in particular on a Smartphone or a tablet PC, or on a head unit of the vehicle.

The second communication protocol can enable a charging station and a vehicle which are interconnected via a charging cable to transmit and receive additional data relating to an identity of the vehicle, relating to a duration of the charging process, relating to a characteristic (e.g. the costs or the energy mix) of the electrical energy provided by the charging station, and/or relating to the billing for the electrical energy provided by the charging station in the charging process. The additional data can be used to provide additional services such as Smart Charging and/or Plug&Charge. The aforementioned charging station data may comprise, for example, additional data.

The additional data can typically not be transmitted or received via the first communication protocol. However, the communication module can be configured to transmit the additional data from the charging station to the user unit and/or vice versa. Additional services can thus be controlled and configured by the user unit in an efficient manner, even though they cannot be provided by the first communication protocol supported by the vehicle.

The communication module may comprise a first communication unit which is configured to set up a first communication connection to the vehicle according to the first communication protocol via a first cable section of the charging cable. The communication module may furthermore comprise a second communication unit which is configured to set up a second communication connection to the charging station according to the second communication protocol via a second cable section of the charging cable. The communication module may furthermore comprise a third communication unit which is configured to set up a third communication connection (e.g. a WLAN connection) to the user unit via the transmission medium separated from the charging cable.

The communication module may furthermore comprise a control unit which is configured to determine whether the charging station data can be transmitted to the vehicle via the first communication protocol. The control unit can furthermore be configured, where appropriate, to prompt the first communication unit to transmit the data corresponding to the charging station data to the vehicle according to the first communication protocol. The control unit can furthermore be configured, where appropriate, to prompt the third communication unit to transmit the data corresponding to the charging station data to the user unit.

The communication module can furthermore be configured to receive user unit data from the user unit and to determine whether the user unit data should be forwarded to the charging station. The communication module can furthermore be configured, where appropriate, to transmit data corresponding to the user unit data to the charging station according to the second communication protocol. Data can thus be exchanged between the user unit and the charging station, particularly in order to provide additional services for the charging process.

According to a further aspect, a charging cable is described for an electrical charging process of a vehicle at a charging station. The charging cable comprises an interface (e.g. a charging plug) on the vehicle side which is configured to form an electrically conducting connection to a corresponding interface (e.g. to a charging socket) of the vehicle. The charging cable furthermore comprises the communication module described in this document. The charging cable furthermore comprises a first cable section which connects the interface on the vehicle side to the communication module. The charging cable furthermore comprises an interface (e.g. a plug) on the charging station side which is configured to form an electrically conducting connection to a corresponding interface of the charging station. The charging cable furthermore comprises a second cable section which connects the interface on the charging station side to the communication module. A charging cable of this type enables the provision of additional services for a charging process in a flexible and efficient manner, even if the vehicle has restricted communication capabilities.

It should be noted that the methods, devices and systems described in this document can be used both alone and in combination with other methods, devices and systems described in this document. Any aspects of the methods, devices and systems described in this document can be combined with one another in a variety of ways. In particular, the features of the claims can be combined with one another in a variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an embodiment of a charging system for a vehicle in accordance with the present invention.

FIG. 2 shows an assignment of pins or contact parts of a charging socket of a vehicle in accordance with an embodiment of the present invention.

FIG. 3 shows components of a charging device on the vehicle side in accordance with an embodiment of the present invention.

FIG. 4 shows a communication module in accordance with an embodiment of the present invention.

FIG. 5 shows a flow diagram of a method for controlling a charging process in accordance with an embodiment of the present invention.

FIG. 6 shows a flow diagram of a method for exchanging information relating to a charging process in accordance with an embodiment of the present invention.

### DETAILED DESCRIPTION OF THE DRAWINGS

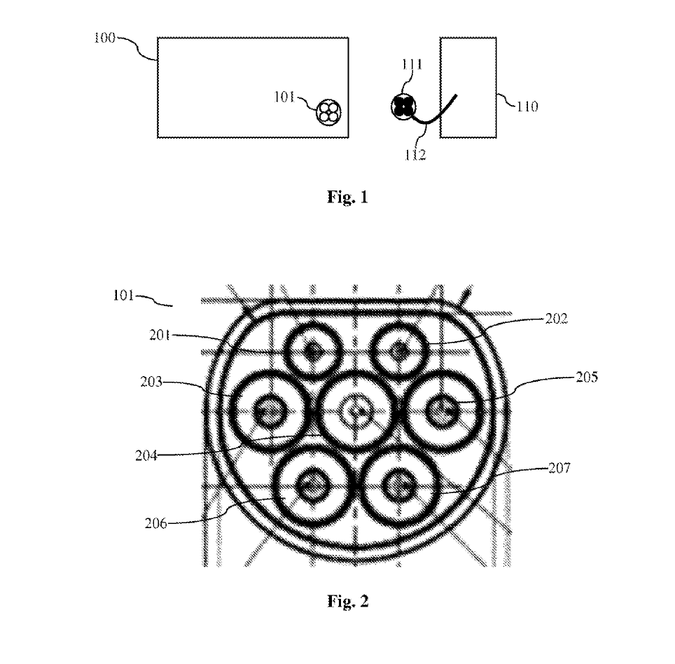

FIG. 1 shows a block diagram of an example of a charging system with a charging station 110 and a vehicle 100. The vehicle 100 comprises an electrical store (not shown) which can be charged with electrical energy from the charging station 110. The vehicle 100 comprises a charging socket 101 to which a corresponding plug 111 of a charging cable 112 can be connected. The charging socket 101 and the plug 111 form a plug-in system. The charging cable 112 can be permanently connected to the charging station 110 (as shown). Conversely, the charging cable 112 can be connected to the charging station 110 via a plug-in connection (e.g. for AC charging).

As shown in FIG. 1, the charging socket 101 is fitted to the vehicle 100. The charging plug (or coupler) 111 is permanently connected to the charging station 110 via the charging cable 112, in particular for DC charging. Different plug variants according to the IEC 62196-3 plug standard exist: Combo 1, Combo 2, DC Type 1, DC Type 2. Both Combo 1 and Combo 2 are connected to the vehicle via the same plug-in architecture. In the case of DC Type 1 and DC Type 2, the same pins (i.e. the same electrical contact parts) of the plug-in system are used in part for AC and DC charging. In particular, for DC Type 2 plug-in systems, the contact parts for L2/DC− and L3/DC+ are used jointly for AC charging and DC charging.

FIG. 2 shows an example of a charging socket 101 with a multiplicity of contact parts 201, 202, 203, 204, 205, 206, 207. The contact parts may have a different function depending on the plug standard and/or depending on the charging type (i.e. DC charging or AC charging). For example, the contact part (also referred to as a pin) 202 can be used to transmit a pilot signal (and can be connected to a pilot line of the charging cable 112). The contact part 201 can be used to transmit a proxy signal. The contact parts 201, 202 can also be referred to as communication contact parts, since they are configured to enable communication signals for a communication between the charging station 110 and the vehicle 100 relating to the charging process. The contact part 205 can be used for the N-conductor of an AC current and the contact part 203 can be used for a first phase L1 of the AC current. The contact part 207 can be used in AC charging for a second phase L2 of the AC current and in DC charging for DC− (DC Minus). Similarly, the contact part 206 can be used in AC charging for a third phase L3 of the AC current and in DC charging for DC+ (DC Plus). The contact parts 203, 205, 206, 207 can be referred to as power contact parts, since they are configured to transmit electrical current for charging the electrical store of the vehicle 100. The contact part 204 can provide a connection to ground. It should be noted that the aforementioned assignment of the contact parts of a charging socket 101 is given by way of example, and other assignments are possible. The charging cable 112 comprises lines corresponding to the contact part 201, 202, 203, 204, 205, 206, 207 (or to some of the contact parts 201, 202, 203, 204, 205, 206, 207).

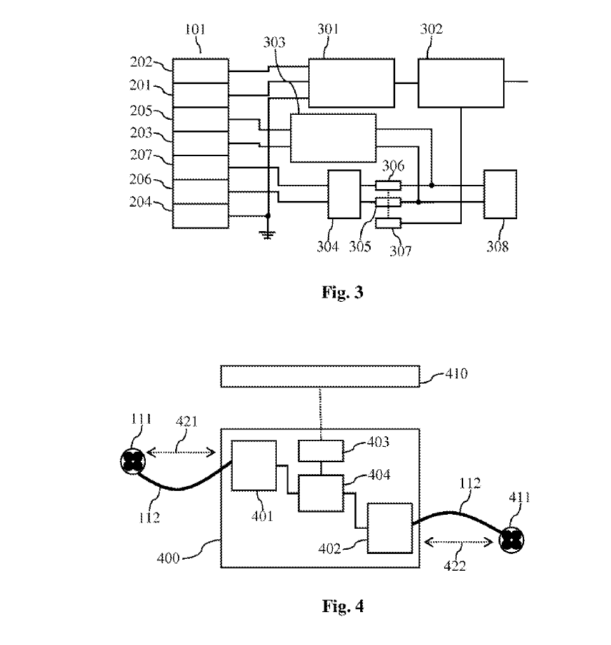

FIG. 3 shows a block diagram of examples of components of a vehicle 100 for charging an electric store 308 of the vehicle 100. The components can be part of a charging device of the vehicle 100. The vehicle 100 comprises the charging socket 101, an AC charging device 303, a communication unit 301, a charging control unit 302, the HV battery 308, a DC contactor 305, 306, 307, and a voltage measurement 304. The AC charging device 303 is typically used for AC charging only. The DC contactor 305, 306, 307 can be used in DC charging to couple the contact parts 206, 207 directly with the energy store 308. The AC charging device 303 can provide single-phase (1 ph) operation (as shown in FIG. 3) or three-phase operation (3 ph). For three-phase operation, the contact part 207 (for the second phase L2) and the contact part 206 (for the third phase L3) are additionally connected to the AC charging device 303.

The charging device of the vehicle 100 can be configured to communicate with a charging station 110 according to a first communication protocol. As shown in connection with FIG. 2, a pilot signal can be exchanged with the charging station 110, in particular via the contact part 202 and via a corresponding pilot line of the charging cable 112. In particular, a pilot circuit can be enabled via the contact part 202 and the corresponding line in the charging cable 112, said circuit serving to exchange the pilot signal between a control unit of the charging station and the communication unit 301 or the charging control unit 302 of the vehicle 100. The charging control unit 302 of the vehicle 100 can be configured to notify a charging-related state of the vehicle 100 by setting a predefined level of the pilot signal. The control unit of the charging station 110 can be configured, through pulse width modulation (e.g. between 7% and 97% duty cycle) of the pilot signal, to notify the vehicle 100 of the maximum current strength or charging power that can be provided by the charging station 110. The pilot signal can oscillate at a predefined frequency (e.g. 1 kHz) between two predefined levels.

An example of a level-based and/or PWM-based communication protocol of this type is the IEC 61851-1 standard. This standard defines different modes, wherein, in particular, Mode 3 and Mode 4 are relevant in connection with the charging at a charging station 110. In particular, Mode 3 is relevant to AC charging and Mode 4 to DC charging at a charging station 110. The communication protocol according to the IEC 61851-1 standard is limited as far as possible to the transmission of the status of the vehicle 100 (whether a charging connection to the charging station 110 does or does not exist) and to the transmission of the maximum charging power (by means of PWM).

Due to the unidirectional charging communication according to the IEC 61851-1 standard, no vehicle data can be communicated to the charging station 110. In particular, the IEC 61851-1 standard enables no functions such as incentive-based Smart Charging and Plug&Charge.

In order to enable an extended exchange of information between the vehicle 100 and the charging station 110, a communication protocol can be used which allows the exchange of messages between the vehicle 100 and the charging station 110. An example of a communication protocol of this type is specified in the ISO/IEC 15118 standard. The ISO/IEC 15118 standard users Power Line Communication (PLC) to transmit data via the pilot line. In particular, data packets can be exchanged between the control unit of the charging station 110 and the charging control unit 302 of the vehicle 100 on the basis of PLC data packets.

The communication protocol according to the ISO/IEC 15118 standard enables messages to be exchanged between the vehicle 100 and the charging station 110 with which the vehicle 100 can identify and, if necessary, authenticate itself to the charging station 110. The charging station 110 can furthermore inform the vehicle 100 of the costs for electrical energy. Information relating to the time duration of a charging process and/or relating to the billing of the costs of the charging process can furthermore be exchanged. The communication protocol according to the ISO/IEC 15118 standard thus enables the provision of additional functions, such as e.g. the time-shifted (possibly cost-optimized) performance of the charging process.

A vehicle 100 and a charging station 110 can be configured to use different communication protocols. For example, the vehicle 100 can use a first communication protocol (e.g. according to the IEC 61851-1 standard) and the charging station 110 can use a second communication protocol e.g. according to the ISO/IEC 15118 standard). The first communication protocol can have a reduced functional scope compared with the second communication protocol.

FIG. 4 shows a communication module 400 which enables a user of the vehicle 100 with the first communication protocol to use the extended functional scope of the second communication protocol when charging at the charging station 110 which uses the second communication protocol. The communication module 400 is configured to communicate with the charging station 110 via the second communication protocol 422 and with the vehicle 100 via the first communication protocol 421. In particular, the communication module 400 comprises a first communication unit 401 which is configured to set up and maintain a first communication connection to the communication unit 301 of the vehicle 100 according to the first communication protocol 421. The communication module 400 furthermore comprises a second communication unit 402 which is configured to set up and maintain a second communication connection to the charging station 110 (in particular to a communication unit of the charging station 110) according to the second communication protocol 422.

The communication module 400 can be part of the charging cable 112. In particular, the communication module 400 can be connected via a first cable section of the charging cable 112 to a charging plug 111 on the vehicle side. The communication module 400 can furthermore be connected via a second cable section of the charging cable 112 to the charging station 110 or to a charging plug 411 on the charging station side. The charging plugs 111, 411 may, for example, be IEC 62196-3 Type 1/2 plugs. The charging cable 112 may be an IEC 61851 Mode 3 charging cable (for AC charging). A charging process for AC charging can thus be enabled. The communication module 400 can be disposed as a hardware/software unit in a housing on the charging cable 422 between the vehicle 100 and the charging station 110.

The communication module 400 comprises a control unit 404 which is configured to enable an internal communication connection between the first and second communication unit 401, 402. In particular, a message received from the charging station 110 can be evaluated and, if it enables the first communication protocol 421, can be forwarded via the charging cable 112 to the vehicle 100. The respective communication format can be used for this purpose (i.e., for example, PLC in the case of the second communication protocol 402 or PWM in the case of the first communication protocol 421). In a similar manner, a message/information received from the vehicle 100 can be forwarded via the charging cable 112 to the charging station.

The control unit 404 is furthermore configured to set up a third communication connection (e.g. a wireless communication connection, such as, for example, WLAN or Bluetooth) via a third communication unit 403 to a user unit 410. The user unit 410 can provide a user interface for a user of the vehicle 100. The user unit 410 may comprise, in particular, a software application which is installed e.g. on a personal electronic device (e.g. on a Smartphone) of the user and/or on a head unit of the vehicle 100. The user unit 410 can enable a user to enter data which are intended to be transmitted to the charging station 110, and/or to receive and/or view data from the charging station 110.

The control unit 404 of the communication module 400 is configured to forward a message from the charging station 110 received via the second communication protocol 422 to the user unit 410. In particular, a message which cannot be transmitted directly to the vehicle 100 via the first communication protocol 421 can be transmitted to the user unit 410. For example, information relating to additional services of the charging station can be forwarded to the user unit 410.

In the opposite direction, the control unit 404 is configured to transmit data received from the user unit 410 to the charging station 110 via the second communication protocol 422. For example, data which enable the identification/authentication of the vehicle 100 at the charging station 110 can be transmitted via the user unit 410 to the charging station 110.

The control unit 404 can be configured to enable a direct communication between the charging station 110 and the vehicle 100 to the extent that this is enabled by the overlap of the functions from the first communication protocol 421 and the second communication protocol 422. Conversely, functions which are possible only via the second communication protocol 422 can be provided through a connection between the user unit 410 and the charging station 110.

In one specific example, the first communication protocol 421 corresponds to the IEC 61851-1 standard and the second communication protocol corresponds to the ISO/IEC 15118 standard. The first communication unit 401 is then configured to inject a PWM signal onto the pilot power of the charging cable 112 in order to communicate the maximum charging power of the charging station 110 to the vehicle 100. This information may have been transmitted previously from the charging station 110 via a corresponding ISO/IEC 15118 message to the communication module 400. The second communication unit 402 is configured for this purpose to set up a PLC data connection to the charging station 110.

Messages from the ISO/IEC 15118 standard which cannot be transmitted to the vehicle 100 according to the IEC 61851-1 standard or which cannot be provided by the vehicle 100 according to the IEC 61851-1 standard can be transmitted to the user unit 410 or can be provided by the user unit 410. The implementation of functions such as Smart Charging and/or Plug&Charge is thus enabled, despite the limited communication capabilities of the vehicle 100.

A converter to be retrofitted inside the vehicle or a Mode 3 cable converter inside the vehicle which enables a simple retrofitting of charging functions is thus provided by the communication module 400. The communication module 400 can be configured to interpret ISO 15118 messages, particularly relating to Smart Charging and/or Plug&Charge. Conversely, the communication module can be configured to control an AC charging process according to IEC 61851-1. The communication module 400 can be configured and controlled via the user unit 410.

The communication module 400 enables an efficient functional extension of vehicles 100 which implement a charging communication according to the IEC 61851-1 standard. In particular, functions such as Smart Charging and/or Plug&Charge can be provided.

FIG. 5 shows a flow diagram of an example of a method 500 for controlling an electrical charging process of a vehicle 100 at a charging station 110 via a charging cable 112. In particular, an AC charging process can be controlled. The vehicle 100 is configured to communicate via the charging cable 112 according to a first communication protocol 421. The charging station 110 is configured to communicate via the charging cable 112 according to a second communication protocol 422. The second communication protocol 422 enables the transmission of data or information which cannot be transmitted with the first communication protocol 421.

The method 500 comprises receiving 501 charging station data according to the second communication protocol 422 from the charging station 110. The charging station data can, in particular, be received by the communication module 400 described in this document. The method 500 furthermore comprises determining 502 whether the first communication protocol 421 enables the transmission of charging station data. The method 500 furthermore comprises transmitting 503 the charging station data (or corresponding data) according to the first communication protocol 421 to the vehicle 100 if it is determined that the first communication protocol 421 enables the transmission of charging station data. The charging process can thus be controlled directly between the vehicle 100 and the charging station 110. The method 500 may furthermore comprise transmitting 503 the charging station data (or corresponding data) via a transmission medium (e.g. via a WLAN connection) separated from the charging cable 112 to the user unit 410, in particular if it is determined that the first communication protocol 421 does not enable the transmission of charging station data. Additional services for the charging process can thus be provided where appropriate via the user unit 410.

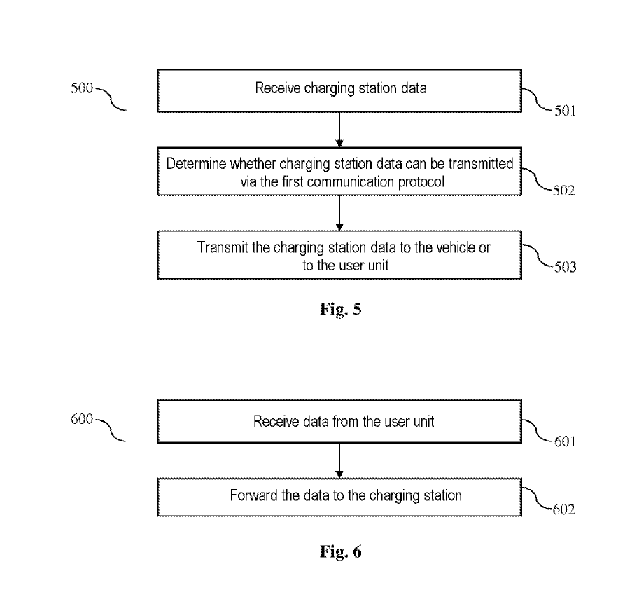

FIG. 6 shows a flow diagram of an example of a method 600 for exchanging information relating to a charging process. As explained above, data (in particular additional data) can be transmitted from the charging station 110 via the communication module 400 to the user unit 410. In the opposite direction (and, where appropriate, in response to the reception of data from the charging station 110), the user unit 410 can transmit data (e.g. a specific selection) to the charging station 110 via the communication module 400. The method 600 therefore comprises receiving 601 data from the user unit 410 on the communication module 400. The method 600 furthermore comprises forwarding 602 these data (typically in a format which corresponds to the second communication protocol 422) to the charging station 110. To do this, the communication module 400 can, where appropriate, convert the data into the second communication protocol 422. A two-way communication between the charging station 110 and the user unit 410 can thus be implemented using the methods 500, 600.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A communication module for use in an electrical charging process of a vehicle configured to communicate with a charging station, comprising:
a module configured to be located on a charging cable between at the charging station and the vehicle,
wherein
the vehicle is configured to communicate via the charging cable using a first communication protocol,
the charging station is configured to communicate via the charging cable using a second communication protocol which enables the transmission of data which cannot be transmitted with the first communication protocol, and
the communication module is configured to
receive charging station data from the charging station using the second communication protocol,
transmit data corresponding to the charging station data to the vehicle using the first communication protocol if the first communication protocol enables the transmission of the charging station data, and
if the first communication protocol does not enable the transmission of the charging station data, transmit data corresponding to the charging station data via a transmission medium to a user unit.

2. The communication module as claimed in claim 1, wherein:
the charging cable includes a communication line,
the first communication protocol uses a pulse-width-modulated signal on the communication line to transmit data; and
the second communication protocol uses Power Line Communication to transmit data on the communication line.

3. The communication module as claimed in claim 1, wherein:
the first communication protocol enables communication according to the IEC 61851-1 standard, and/or
the second communication protocol enables communication according to the ISO/IEC 15118 standard.

4. The communication module as claimed in claim 1, wherein
the transmission medium includes a wireless transmission medium, and
the communication module is configured to set up at least one of a WLAN and a Bluetooth connection to the user unit over the wireless transmission medium.

5. The communication module as claimed in claim 1, wherein
the user unit includes
a software application configured to communicate with the module, and
a user interface for a user of the vehicle of at least one of a personal electronic device and a head unit of the vehicle.

6. The communication module as claimed in claim 1, wherein
the first communication protocol enables at least one of
the charging station to determine whether the vehicle is connected via the charging cable to the charging station, and
the vehicle to determine a maximum charging power which can be provided by the charging station via the charging cable.

7. The communication module as claimed in claim 6, wherein
the second communication protocol enables the charging station and the vehicle to transmit and receive via a charging cable additional data relating to an identity of the vehicle, relating to at least one of
a duration of the charging process,
a characteristic of the electrical energy provided by the charging station, and
billing for electrical energy provided by the charging station to the vehicle,
the communication module is configured to transmit the additional data between from the charging station and the user unit if the additional data cannot be transmitted or received via the first communication protocol.

8. The communication module as claimed in claim 1, wherein
the communication module comprises
a first communication unit configured to set up a first communication connection to the vehicle using the first communication protocol via a first cable section of the charging cable,
a second communication unit configured to set up a second communication connection to the charging station using the second communication protocol via a second cable section of the charging cable,
a third communication unit configured to set up a third communication connection to the user unit via the transmission medium, and
a control unit configured to determine whether the charging station data can be transmitted to the vehicle using the first communication protocol and either
prompt the first communication unit to transmit the data corresponding to the charging station data to the vehicle using the first communication protocol if the charging station data is transmittable using the first communication protocol, or
prompt the third communication unit to transmit the data corresponding to the charging station data to the user unit if the charging station data is not transmittable using the first communication protocol.

9. The communication module claimed in claim 8, wherein
the communication module is configured to
receive user unit data from the user unit, and
transmit data corresponding to the user unit data to the charging station according to the second communication protocol if the communication module determines the user unit data should be forwarded to the charging station.

10. A charging cable for an electrical charging process of a vehicle at a charging station, the charging cable comprising:
an interface on a vehicle side of the charging cable configured to form an electrically conducting connection with a corresponding interface of the vehicle;
a communication module configured to
receive charging station data from the charging station,
transmit data corresponding to the charging station data to the vehicle using a first communication protocol used by the vehicle if the first communication protocol enables the transmission of the charging station data to the vehicle, and
if the first communication protocol does not enable the transmission of the charging station data to the vehicle, transmit data corresponding to the charging station data via a transmission medium to a user unit;
a first cable section configured to connect the interface on the vehicle side to the communication module;
an interface on the charging station side of the charging cable configured to form an electrically conducting connection with a corresponding interface of the charging station; and
a second cable section configured to connect the interface on the charging station side to the communication module.
